(19) United States
(12) Patent Application Publication
(10) Pub. No.: US 2024/0076515 A1
(43) Pub. Date: Mar. 7, 2024

(54) POLYURETHANE DISPERSANTS, PIGMENT DISPERSIONS AND AQUEOUS INKS

(71) Applicant: Sun Chemical Corporation, Parsippany, NJ (US)

(72) Inventors: Mark ORTALANO, Amelia, OH (US); Ralph ARCURIO, Carlstadt, NJ (US); Mihaela MADARAS, Cincinnati, OH (US); Xiaobo ZHU, Carlstadt, NJ (US)

(21) Appl. No.: 18/508,352

(22) Filed: Nov. 14, 2023

Related U.S. Application Data
(63) Continuation of application No. PCT/US22/29986, filed on May 19, 2022.
(60) Provisional application No. 63/190,946, filed on May 20, 2021.

(51) Int. Cl. C09D 17/00; C08G 18/08; C08G 18/32; C08G 18/34; C08G 18/48; C09B 67/08; C09B 67/20; C09D 11/037; C09D 11/322

(52) U.S. Cl. CPC C09D 17/003; C08G 18/0823; C08G 18/3206; C08G 18/348; C08G 18/4837; C08G 18/4854; C09B 67/0013; C09B 67/0066; C09D 11/037; C09D 11/322

(57) ABSTRACT

This development pertains to polyurethane resins for producing stable pigment dispersions that are compatible with co-solvents and humectants used in aqueous ink jet inks. Inks with improved flow in printhead and penetration of substrate may be obtained.

### BACKGROUND

Aqueous polyurethanes (PU's) are presently used in aqueous ink jet inks to provide good adhesion and resistance properties. However, compatibility of aqueous polyurethanes with pigment dispersions is generally poor. This is due to the incompatibility of the polyurethane dispersant (PUD) resins used for pigment dispersion. A polyurethane resin used as a pigment dispersant would be more compatible than traditional dispersants (such as surfactants or other polymers) and will not detract from the positive resistance properties provided by the PUD's.

Polyurethane dispersant resins for aqueous systems may be commercially difficult to prepare and do not always provide the optimal dispersion properties. It is the goal of this development to provide PUD's that provide stable pigment dispersions and that are compatible with co-solvents and humectants, that in themselves provide excellent viscosity control, resolubility in the printhead and penetration of the substrate. “Resolubility” of the ink relates to the ability of the dry ink to be redissolved by the same ink in the wet state. This may be very significant when the ink is running on the printer. If this property is missing, the ink dries in the printhead.

### BRIEF DESCRIPTION OF THE DRAWINGS

FIG. 1. shows a “brush” type structure of the PEG groups appended on carbon backbone of the polyurethane polymer.

### BRIEF DESCRIPTION

The present development relates to a polyurethane resin pigment dispersant comprising a water-based polyurethane polymer with pendant polyethylene glycol (PEG) groups appended on a carbon backbone of the polyurethane polymer. The water-based polyurethane polymer may be ionic or non-ionic. The polyurethane polymer has units derived from a polyisocyanate, a polyol, a polyether polyol having no acid group, and a PEG diol or a diol having an acid group, where the diol of the acid group may be a salt selected from the group consisting of Li, Na, or K, an organic amine, and ammonia.

The polyisocyanate of the dispersant is selected from the group consisting of aliphatic polyisocyanates, alicyclic polyisocyanates, aromatic polyisocyanates, araliphatic polyisocyanates and combinations thereof, wherein percentage (% by mass) of the units derived from the polyisocyanate in the polyurethane polymer is ≥10% by mass to ≤80% by mass.polyether polyol having no acid group has a polystyrene-equivalent number-average molecular weight of between 450-4,000 as determined by gas-phase chromatography. The percentage (% by mass) of the unit(s) derived from the polyether polyol having no acid group in the polyurethane polymer is from 0.1-80%. The dispersant of may also comprise a unit derived from DMPA and DMBA as a diol having an acid group.

The polyether polyol of the polyurethane polymer may be selected from the group consisting of poly(alkylene glycol)s, addition polymers of alkylene oxides, dihydric alcohols, and trivalent polyhydric alcohols. The addition polymers of alkylene oxides are selected from the group consisting of include ethylene oxide, propylene oxide, butylene oxide and alpha-olefin oxides and combinations thereof. The dihydric alcohol is selected from the group consisting of, hexamethylene glycol, tetramethylene glycol, ethylene glycol, diethylene glycol, propylene glycol, dipropylene glycol, 1,3-butanediol, 1,4-butanediol, 4,4-dihydroxyphenylpropane, 4,4-dihydroxyphenylmethane and combinations thereof. The trivalent polyhydric alcohols are selected from the group consisting of glycerin, trimethylolpropane, 1,2,5-hexanetriol, 1,2,6-hexanetriol, pentaerythritol and combinations thereof.

The PEG diol of the polyurethane polymer may be selected from the group consisting of poly(ethylene glycol), poly(propylene glycol), poly(tetramethylene glycol), poly(1,2-butylene glycol), poly(1,3-butylene glycol), ethylene glycol-propylene glycol copolymers, and combinations thereof.

The polyurethane resin pigment dispersant may also comprise a chain extension agent wherein the chain extension agent is selected from the group consisting of polyvalent amine compounds, such as trimethylolmelamine and derivatives thereof, dimethylolurea and derivatives thereof, dimethylolethylamine; diethanolmethylamine; dipropanolethylamine; dibutanolmethylamine; ethylenediamine; propylenediamine; diethylenetriamine; hexylenediamine; triethylenetetramine; tetraethylenepentamine; isophoronediamine; xylylenediamine; diphenylmethanediamine; hydrogenated diphenylmethanediamine; hydrazine; polyamide polyamine; polyethylene polyimine; ethylene glycol; propylene glycol; 1,3-propanediol; 1,3-butanediol; 1,4-butanediol; 1,5-pentanediol; 1,6-hexanediol; neopentyl glycol; diethylene glycol; triethylene glycol; tetraethylene glycol; dipropylene glycol; tripropylene glycol; poly(ethylene glycol); 3-methyl-1,5-pentanediol; 2-butyl-2-ethyl-1,3-propanediol; 1,4-cyclohexanediol; 1,4-cyclohexanedimethanol; hydrogenated bisphenol A; glycerin; trimethylolpropane; pentaerythritol and combinations thereof.

The polyurethane resin pigment dispersant may also comprise a resin co-dispersant, wherein the resin co-dispersant is selected from the group consisting of acrylic acids, methacrylates, styrene acrylics, styrene maleic anhydrides and combinations thereof. The dispersant may also comprise one or more additives, wherein the one or more additives are selected from the group consisting of biocides, defoamers, humectants and pH adjustors.

The polyurethane resin pigment dispersant may be used in dispersions generally, printing inks, including, but not limited an inkjet ink.

### DETAILED DESCRIPTION

The present development is directed to water-based (aqueous) polyurethane (PU) resins for producing stable pigment dispersions that are compatible with co-solvents and humectants used in inks, including, but not limited to aqueous ink jet inks and the like. When used in inkjet inks, the PU resins may provide improved resolubility in printhead and penetration of substrate.

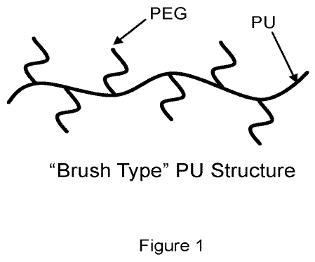

The water-based polyurethanes (PU) of the present development may have pendant polyethylene glycol (PEG) groups appended on the PU carbon “backbone” which may enable the resulting pigment dispersion to be more stable and compatible with co-solvents and humectants, that in themselves provide excellent viscosity control and resolubility. The pendant PEG groups appended on the carbon backbone of the polyurethane polymer may provide a “brush” type structure, which is thought to ideal to stabilize the pigments (FIG. 1).

In a one embodiment, all raw materials used in the polyurethane dispersions of the present development are Swiss Ordinance listed (compliant), which would make them suitable for use in inks intended for food and personal care packaging applications.

Aqueous ink jet inks typically require high water and rub fastness due to their use in packaging and textile applications. Adhesion to various substrates, including non-porous substrates, is important for packaging inks, while adhesion to fibers is important for textile inks. Water resistance is important for packaging inks, while overall durability and wash fastness is important for textile inks. Co-solvents and humectants may be used in inks for penetration and latency. Inks should preferably be stable against particle size growth and viscosity change due to operating parameters of the printhead, and this stability can be influenced by co-solvents and humectants. For example, glycerine is often used in textile inks for penetration, and other glycols may used in inks to modify viscosity to be optimal for the specific printhead and application.

Inks may be formulated with polyurethane dispersions (PUD's) and may also be formulated in combination with other polymers in order to achieve improved durability and resistance. However, care must be taken in the selection of PUD's in order to avoid instabilities in inks.

Pigmented inks may be most commonly used in commercial applications due to higher performance of pigmented inks versus use of dyes in textiles. Pigmented inks are almost exclusively used in packaging. Choice of pigmented inks may depend upon color requirements and resistance properties, including wash fastness, light fastness and water resistance for the intended use.

Pigments may be dispersed into water by surfactants, polymers and resins of various molecular weights. Surfactant-stabilized pigment dispersions may have very good stability but typically offer poor water resistance and wash fastness. Pigments stabilized in water by using styrene acrylic resins are very commonly known and may provide good stability and resistance properties for pigmented inks, however, these may also raise the viscosity of pigmented(?) inks beyond the operating parameters of the printhead and are not always compatible with PUD's contained in the inks.

Polyurethane resins used as dispersants would be most compatible with PUD's found in inks; however, these are less common, and very few examples of water-based polyurethane dispersants are commercially available. Additionally, some are not optimal in stabilizing against certain co-solvents or humectants, and others do not work with difficult-to-stabilize pigments, such as quinacridone magenta.

It is the purpose of the present development to provide polyurethane resins as dispersants to provide stable pigment dispersions containing those resins, and stable pigmented inks containing those dispersions.

Polyurethane dispersants (PUD's) of the following types have been synthesized:
(1) Type 1 Non-ionic TDI/PEG PUD with pendant PEG appended on the carbon backbone of the polyurethane polymer.
   (where TDI=Toluene Di-Isocyanate; PEG=Polyethylene Glycol; PUD=Polyurethane Dispersant)
(2) Type 2: Anionic potassium hydroxide (KOH) neutralized PTHF 1K-DMPA-IPDI-TEGOMER D3403 based PU use MEA as chain extender. (where=PTHIF1K-DMPA-IPDI-TEGOMER D3403; PU=polyurethane polymer; MEA=Monoethanolamine)

### Polyurethane Polymer:

The polyurethane polymer has units derived from a polyisocyanate; a polyol or polyether polyol having no acid group; and a PEG diol or a diol having an acid group. The polyurethane polymer of the present development will be described below in detail.

### Polyisocyanate:

The term “polyisocyanate”, as used herein, refers to a compound having two or more isocyanate groups. Examples of the polyisocyanate for use in an embodiment of the present development include, but are not limited to, aliphatic polyisocyanates, alicyclic polyisocyanates, aromatic polyisocyanates, and araliphatic polyisocyanates. The percentage (% by mass) of the unit(s) derived from the polyisocyanate in the polyurethane polymer may be ≥10% by mass, or ≤80% by mass. The percentage (% by mass) of the unit(s) derived from the polyisocyanate in the polyurethane polymer may also be ≥30% by mass, or ≤60% by mass.

Examples of the aliphatic polyisocyanates include, but are not limited to, tetramethylene diisocyanate, dodecamethylene diisocyanate, hexamethylene diisocyanate, 2,2,4-trimethylhexamethylene diisocyanate, 2,4,4-trimethylhexamethylene diisocyanate, lysine diisocyanate, 2-methylpentane-1,5-diisocyanate, and 3-methylpentane-1,5-diisocyanate.

Examples of the alicyclic polyisocyanates include, but are not limited to, isophorone diisocyanate, hydrogenated xylylene diisocyanate, 4,4-dicyclohexylmethane diisocyanate, 1,4-cyclohexane diisocyanate, methylcyclohexylene diisocyanate, and 1,3-bis(isocyanatomethyl)cyclohexane.

Examples of the aromatic polyisocyanates include, but are not limited to, tolylene diisocyanate, 2,2-diphenylmethane diisocyanate, 2,4-diphenylmethane diisocyanate, 4,4-diphenylmethane diisocyanate, 4,4-dibenzyl diisocyanate, 1,5-naphthylene diisocyanate, xylylene diisocyanate, 1,3-phenylene diisocyanate, and 1,4-phenylene diisocyanate. Examples of the araliphatic polyisocyanates include, but are not limited to, dialkyldiphenylmethane diisocyanate, tetraalkyldiphenylmethane diisocyanate, and alpha,alpha,alpha,alpha-tetramethylxylylene diisocyanate.

Any of theses polyisocyanates may be used alone or in combination with other polyisocyanates. Among these polyisocyanates, hexamethylene diisocyanate may be used in an embodiment of the present development. Hexamethylene diisocyanate may be used in combination with another polyisocyanate. The reason for this is described below.

Hexamethylene diisocyanate (hereinafter referred to as HDI) has a straight chain structure, with minimal steric hindrance, and high molecular symmetry. It is thought that in a polyurethane polymer synthesized using HDI, the HDI molecules may tend to gather due to hydrogen bond formation via the urethane bonds. Thus, in a polyurethane polymer synthesized using HDI, rigid segments containing the polyisocyanate are localized. This tends to result in micro phase separation in which the rigid segments are present in a continuous soft segment to form a “sea-island” structure, thus markedly increasing the flexibility of the polyurethane polymer. In contrast, it is thought that a polyisocyanate that has an intramolecular branched or ring structure would have large steric hindrance and rarely form hydrogen bonds.

However, an interaction between the ring structures and hydrophobic interactions may increase the number of hard segments and markedly increase the strength of the polyurethane polymer. Thus, use of HDI in combination with another polyisocyanate may impart flexibility due to the presence of HDI, and also impart additional strength due to the additional polyisocyanate, thereby achieving higher scratch resistance and highlighter resistance of an image (i.e. wiping the image with a felt tip highlighter marker, such as from BIC).

The percentage (% by mole) constituted by the unit(s) derived from HDI with respect to all the units derived from the polyisocyanate in the polyurethane polymer may be ≥10% by mole, or ≤90% by mole. The percentage (% by mass) of the unit(s) derived from the polyisocyanate in the polyurethane polymer may also be ≥30% by mass, or ≤60% by mass.

The balance of the effect of improving strength and flexibility between HDI and the polyisocyanate other than HDI is satisfactory within this range. This further improves the scratch resistance and highlighter resistance of an image.

### Polyether Polyol Having No Acid Group

The polyether polyol having no acid group for use in an embodiment of the present development has a polystyrene-equivalent number-average molecular weight of between 450-4,000 as determined by gel permeation chromatography (GPC). The percentage (% by mass) of the unit(s) derived from the polyether polyol having no acid group in the polyurethane polymer may be between 0.1% by mass −80.0% by mass. The percentage (% by mass) of the unit(s) derived from the polyether polyol having no acid group in the polyurethane polymer may be ≥30% by mass, or ≤50% by mass.

In one embodiment of the present development, the polyether polyol having no acid group may be used in combination with another polyol having no acid group other than the polyether polyol to synthesize the polyurethane polymer. In this case, the percentage (% by mole) constituted by the unit(s) derived from the polyether polyol having no acid group with respect to all the units derived from the polyol having no acid group in the polyurethane polymer may be between 80%-100% by moles. In particular, castor-oil-modified polyol would preferably not be used in view of ink ejection stability.

Examples of the polyether polyol include, but are not limited to, poly(alkylene glycol)s and addition polymers of alkylene oxides and dihydric alcohols or at least trivalent polyhydric alcohols.

Examples of the poly(alkylene glycol)s include, but are not limited to, poly(ethylene glycol), poly(propylene glycol), poly(tetramethylene glycol), poly(1,2-butylene glycol), poly(1,3-butylene glycol), and ethylene glycol-propylene glycol copolymers.

Examples of the dihydric alcohols include, but are not limited to, hexamethylene glycol, tetramethylene glycol, ethylene glycol, diethylene glycol, propylene glycol, dipropylene glycol, 1,3-butanediol, 1,4-butanediol, 4,4-dihydroxyphenylpropane, and 4,4-dihydroxyphenylmethane.

Examples of the at least trivalent polyhydric alcohols include, but are not limited to, glycerin, trimethylolpropane, 1,2,5-hexanetriol, 1,2,6-hexanetriol, and pentaerythritol.

Examples of the alkylene oxides include, but are not limited to, ethylene oxide, propylene oxide, butylene oxide, and alpha-olefin oxides. These polyether polyols may be used alone or in combination.

In one embodiment of the present development, the polyether polyol having no acid group may contain at least one selected from poly(ethylene glycol), poly(propylene glycol), poly(1,2-butylene glycol), and poly(1,3-butylene glycol). Use of these polyether polyols can increase the strength, flexibility, and hydrophilicity of the polyurethane polymer, thereby further improving the scratch resistance and highlighter resistance of an image and ink ejection stability. The percentage (% by mole) constituted by the unit(s) derived from poly(ethylene glycol), poly(propylene glycol), poly(1,2-butylene glycol), and poly(1,3-butylene glycol) with respect to all the units derived from the polyether polyol in the polyurethane polymer may be between 80%-100% by mole. In particular, the polyether polyol having no acid group may contain poly(propylene glycol). Use of poly(propylene glycol) can improve the balance between the strength and the flexibility of the polyurethane polymer film.

Polyol Having ethylene oxide units:

Examples of a polyether having ethylene oxide units may be polyether polyols having ethylene oxide units such as polyethylene glycol, or polyethylene glycol dialkylethers or polyethylene glycol monoalkylethers, wherein two primary hydroxyl groups are incorporated in the polymer. A particular polyether having ethylene oxide units may be a difunctional polyethylene glycol monomethyl ether, wherein two primary hydroxyl groups are incorporated in the polymer such as Ymer® N120 (from Perstorp), TEGOMER D 3403 from Evonik.

### Diol Having Acid Group:

A polyurethane polymer for use in an ink according to an embodiment of the present development has a unit derived from at least one selected from Dimethylolpropionic acid (DMPA) and 2,2-Dimethylolbutanoic acid (DMBA) as a diol having an acid group. The diol having an acid group may be in the form of a salt with an alkali metal, such as Li, Na, or K, or an organic amine, such as ammonia or dimethylamine. These diols may be used alone or in combination. The percentage (% by mass) of the unit(s) derived from the diol having an acid group in the polyurethane polymer may be 5.0% by mass or more and 40.0% by mass or less. The percentage (% by mass) of the unit(s) derived from the diol having an acid group in the polyurethane polymer may also be ≥5.0% by mass, or ≤15.0% by mass.

### Chain Extension Agent

A chain extension agent is a compound that can react with a residual isocyanate group of a polyisocyanate unit of a urethane prepolymer. The residual isocyanate group is an isocyanate group that did not form a urethane bond. In one embodiment of the present development, a chain extension agent may be used in the synthesis of the polyurethane polymer provided that the molar ratio of the urethane bond to the urea bond in the polyurethane polymer is between 85.0/15.0-120.0/0. Examples of the chain extension agent include, but are not limited to, polyvalent amine compounds, such as trimethylolmelamine and derivatives thereof, dimethylolurea and derivatives thereof, dimethylolethylamine, diethanolmethylamine, dipropanolethylamine, dibutanolmethylamine, ethylenediamine, propylenediamine, diethylenetriamine, hexylenediamine, triethylenetetramine, tetraethylenepentamine, isophoronediamine, xylylenediamine, diphenylmethanediamine, hydrogenated diphenylmethanediamine, and hydrazine, polyamide polyamine, and polyethylene polyimine. Examples of the chain extension agent also include, but are not limited to, ethylene glycol, propylene glycol, 1,3-propanediol, 1,3-butanediol, 1,4-butanediol, 1,5-pentanediol, 1,6-hexanediol, neopentyl glycol, diethylene glycol, triethylene glycol, tetraethylene glycol, dipropylene glycol, tripropylene glycol, poly(ethylene glycol), 3-methyl-1,5-pentanediol, 2-butyl-2-ethyl-1,3-propanediol, 1,4-cyclohexanediol, 1,4-cyclohexanedimethanol, hydrogenated bisphenol A, glycerin, trimethylolpropane, and pentaerythritol. These chain extension agents may be used alone or in combination.

Resins co-dispersants may also be used along with the polyurethane if needed. The resins of this development can include but are not limited to acrylic acids or methacrylates, styrene acrylics and styrene maleic anhydrides.

Various additives may also be added to the dispersions. Examples of typical additives are given below, but it is understood that other additives common to the preparation of pigment dispersions could be used, as known to one skilled in the art.

Biocides may be typically added to compositions such as inkjet ink compositions to suppress the growth of microorganisms such as molds and fungi in inks. Example of suitable biocides include, but are not limited to, sodium dehydroacetate, 2-phenoxyethanol, sodium benzoate, sodium pyridinethion-1-oxide, ethyl p-hydroxybenzoate and 1,2-benzisothiazolin-3-one and salts thereof. An exemplary biocide is biocide solution 1,2-Benzisothiazolin-3-one at 19% active.

Defoamers may also be added to the premix composition to prevent foaming of the composition during its preparation. Any suitable defoamer known to those of ordinary skill in the art can be used, preferably those that are miscible with the liquid. Suitable defoamers include, but are not limited to, silicone defoamers and acetylenic defoamers. In some embodiments the defoamer can contain dipropylene glycol and 2,5,8,11-tetramethyl-6-dodecene-5,8-diol. An exemplary defoamer is acetylenic diol defoamer.

Humectants may also be used and include, but are not limited to: glycols, including propylene glycol, polypropylene glycol, ethylene glycol, polyethylene glycol, diethylene glycol, tetraethylene glycol; sorbitol, glycerine, triacetin, N-methyl-2-pyrrolidone, glycerol, urea, thiourea, ethylene urea, alkyl urea, alkyl thiourea, dialkyl urea and dialkyl thiourea, diols, including ethanediols, propanediols, propanetriols, butanediols, pentanediols, and hexanediols; and mixtures and derivatives thereof.

Adjustment of pH may be made by using various amines or bases, included, but not limited to DMAMP-80, AMP-95, MEA, or KOH or ammonia.

The colorant of the present development may be any organic or inorganic pigment or dye or combinations thereof.

A non-limiting list of organic pigments includes any organic pigment belonging to azo, metal complex, benzimidazolone, azomethine, methane, anthraquinone, phthalocyanine, perinone, perylene, diketopyrrolopyrrole, indigo, thioindigo, dioxazine, isoindoline, isoindolinone, iminoisoindoline, iminoisoindolinone, quinacridone, flavanthrone, indanthrone, anthrapyrimidine, quinophthalone, isoviolanthrone, pyranthrone pigments, as well as other organic pigments and combinations thereof.

A non-limiting list of inorganic pigment examples includes carbon black, metal oxide, mixed metal oxide, sulfide, sulfate. Non-limiting specific examples are titanium dioxide, zinc oxide, iron oxide, antimony yellow, lead chromate, lead chromate sulfate, lead molybdate, ultramarine blue, cobalt blue, manganese blue, chrome oxide green, hydrated chrome oxide green, cobalt green, metal sulfides, cadmium sulfoselenides, zinc ferrite, bismuth vanadate, as well as derivatives, other inorganic pigments and any combinations thereof.

The pigment may also be any known “extender,” for example oxide, carbonate, sulfate, sulfide, phosphate, and may be synthetic or mineral. Non-limiting examples of usable extenders may include calcium carbonate, blanc fixe, mica, kaolin, clay, silica, and the like and combinations thereof.

Non-limiting specific examples of organic pigments are C.I. Pigment Black 1, 2, 3, 31 and 32; C.I. Pigment Green 7, 36, 37, 47, 54, and 58; C.I. Pigment Blue 15:1, 15:2, 15:3, 15:4, 15:6, 16, 21, 22, 60, 64, 65, 75, and 76; C.I. Pigment Violet 19, 23, 29, 31, 33, and 37; C.I. Pigment Red 122, 123, 144, 149, 166, 168, 170, 171, 175, 176, 178, 179, 180, 183, 189, 190, 192, 196, 202, 208, 209, 214, 216, 220, 221, 224, 226, 242, 248, 254, 255, 260, 264, and 271; C.I. Pigment Orange 36, 40, 43, 51, 60, 61, 62, 64, 66, 69, 71, 72, 73, and 77; C.I. Pigment Yellow 24, 74, 83, 93, 94, 95, 108, 109, 110, 120, 123, 138, 139, 150, 151, 154, 155, 167, 170, 171, 173, 174, 175, 180, 181, 185, 192, 193, 194, 199, 213, and 218. Also included are mixtures of pigments and mixed crystals.

Non-limiting specific examples of inorganic pigments are Pigment Black 6, 7, 9, 11, 12, 14, 15, 22, 26, 27, 28, 29, 30, 33, 34 and 35; C.I. Pigment Green 18, 20, 21 and 22; C.I. Pigment Blue 27, 30, and 73; C.I. Pigment Red 265 and 275; C.I. Pigment Yellow 38, 40, 53, 119, 157, 158, 160, 161, 162, and 184; C.I. Pigment White 4, 5, 6, 6:1, 7, 8, 9, 10, 12, 13, 14, 15, 18, 18:1, 19, 21, 22, 23, 24, 25, 26, 27, 28, 32, 33, and 36.

A general method of producing the dispersions of the present development is to mix pigment, water, and dispersing resin solutions together, then proceed to milling. The type of milling is not particularly limited. Examples of milling equipment may be media mills, homogenizers, high speed mixers, and mixers with media incorporated within. The media mills may be horizontal, vertical, or batch such as equipment produced under the names of Netzsch, Premier, Hockmeyer, Dyno-mills, ball mills, roller mills and the like. Other equipment that does not use milling media such as homogenizers, three roll mills, two roll mills, and microfluidizers are also acceptable for particle size reduction. Other particle size reduction techniques are also within the scope of this development and are known by those skilled in the art.

For the examples below, milling was performed using a Netzsch LabStar® mill with YTZ media or with a 50 ml Eiger mini-mill using 0.8-1.0 mm ZrSi media, though any suitable milling media may be used including ZrSi, glass, cerium-modified or other.

Testing for stability of particle size and viscosity are conducted at 50° C. for a duration of about one week and to about one month. Particle size was measured on a Microtrac UPA® 250 instrument. Inks were made with dispersion, deionized water and humectants, and aged at 60° C. for one week, with particle size being a key metric for stability. Particle size ranges should have a d50 of less than 200 nm.

The present development has been described in detail, including the preferred embodiments thereof. However, it will be appreciated that those skilled in the art, upon consideration of the present disclosure, may make modifications and/or improvements on this development that fall within the scope and spirit of the development.

### EXAMPLES

The development is further described by the following non-limiting examples which further illustrate the development, and are not intended, nor should they be interpreted to, limit the scope of the development.

### Synthesis of Inventive Polyurethane Resin I1: Non-Ionic TDI/PEG PUD

301.4 g Ymer N 120 and 50.0 g TDI was charged into 1 L flask and slowly heated to 100-110° C. with nitrogen blanket. Hold until the pre-polymer's NCO reaches the desired range. Cool the batch to 100° C. Charge 350.0 g DI water to dissolve the PU into water. Mix for 1 hr. until all the PU is dissolved.

Solids=50.1%,vis.=150cPs.pH=7.4

### Synthesis of Inventive Polyurethane Resin 12: R4126-174 KOH Neutralized PUD Use MEA as Extender.

160.3 g PTHF 1000, 86.3 g Ymer N 120, 32.4 g Jeffamine M-1000,64.8 g DMPA and 256.2 g IPDI was charged into 2 L flask and slowly heated to 85 C with nitrogen blanket. Hold at 85° C. until the reaction is complete.

### Chain Extension and Dispersing:

Pre-heat 669.2 g DI water, 15.0 g Ethanolamine (MEA) and 17.0 g KOH (>85%) in dispersing flask to 45° C., charge above 352.2 pre-polymer over 10-20 mins into the dispersing flask while mixing. The temperature of dispersed PU in the dispersing flask slowly increases to 55-60° C. Apply cooling if the temperature is above 60° C. Continue mixing for 1 hr. after all the pre-polymer is transferred into the dispersing flask. Use KOH to adjust the pH to 7.5-8.5.

Solids=35.8%, pH=8.0, vis.=280 cPs

### Dispersion Example ID1

Polyurethane Example I1 (Non-ionic TDI/PEG PUD, Sun Chemical) was used as the dispersant at 3 parts of Pigment Yellow 74 (272-5147, Sun Chemical) to 1 part of polyurethane to make pigment dispersion, along with water added to balance to 100%. A batch at 20% pigment by weight was milled using a 0.6 L Netzsch LabStar® mill beaded with 0.3 mm YTZ media. Initial viscosity was 5.90 cps and initial particle size (d50) was 158 nm. After aging at 50° C. for four weeks, the resultant viscosity and median particle size was 5.24 cps and 161 nm, respectively.

### Dispersion Example ID2

Polyurethane Example I1 was used as the dispersant at 5 parts of Pigment Black 7 (Special Black 350, Orion) to 1 part of polyurethane to make pigment dispersion, along with water added to balance to 100%. A batch at 20% pigment by weight was milled using a 0.6 L Netzsch LabStar® mill beaded with 0.3 mm YTZ media. Initial viscosity was 2.86 cps and initial particle size (d50) was 155 nm. After aging at 50° C. for four weeks, the resultant viscosity and median particle size was 2.64 cps and 155 nm, respectively.

### Dispersion Example ID3

Polyurethane Example 12 was used as the dispersant at 2 parts of quinacridone magenta (228-2120, Sun Chemical) to 1 part of polyurethane to make pigment dispersion, along with water added to balance to 100%. A batch at 15% pigment by weight was milled using a 0.6 L Netzsch LabStar® mill beaded with 0.3 mm YTZ media. Initial viscosity was 4.05 cps and initial particle size (d50) was 186 nm. After aging at 50° C. for four weeks, the resultant viscosity and median particle size was 3.90 cps and 166 nm, respectively.

### Dispersion Example ID4

Polyurethane Example I1 and a commercial acrylic resin were used as the dispersants at 8 parts of Pigment Blue 15:3 (249-LM84, Sun Chemical) to 1 part of polyurethane and to 1 part of acrylic resin to make pigment dispersion, along with water added to balance to 100% and amine to adjust pH to around 9.5. A batch at 20% pigment by weight was milled using a 0.6 L Netzsch LabStar® mill beaded with 0.3 mm YTZ media. Initial viscosity was 4.80 cps and initial particle size (d50) was 165 nm. After aging at 50° C. for four weeks, the resultant viscosity and median particle size was 5.40 cps and 167 nm, respectively showing that the dispersion is stable.

### Dispersion Example ID5

Polyurethane Example I1 and a commercial SMA resin were used as the dispersants at 8 parts of Pigment Blue 15:3 (249-LM84, Sun Chemical) to 1 part of polyurethane and to 1 part of acrylic resin to make pigment dispersion, along with water added to balance to 100%. A batch at 20% pigment by weight was milled using a 0.6 L Netzsch LabStar® mill beaded with 0.3 mm YTZ media. Initial viscosity was 4.83 cps and initial particle size (d50) was 157 nm. After aging at 50° C. for four weeks, the resultant viscosity and median particle size was 5.04 cps and 162 nm, respectively.

The following comparative examples demonstrate how dispersants based on polymers other than water-based polyurethanes with pendant polyethylene glycol (PEG) groups appended on the carbon backbone may not be suitable for use. Possible issues may include gelling during milling or a sizable viscosity increase during stability testing.

### Comparative Dispersion Example CD1 (Acrylic Block Copolymer Dispersant)

Four parts of quinacridone magenta (228-2120, Sun Chemical) to 1 part of BYK 9171 (solids of dispersant on solids of pigment) was to make the pigment dispersion, along with water added to balance to 100%. A batch at 20% pigment by weight was milled using a 0.6 L Netzsch LabStar® mill beaded with 0.3 mm YTZ media. This dispersion gelled in the mill showing that it is not stable and not suitable.

### Comparative Dispersion Example CD2 (Acrylic Block Copolymer Dispersant)

Five parts of C.I. Pigment Black 7 (Special Black 350, Orion) to 1 part of BYK 9171 (solids of dispersant on solids of pigment) was to make the pigment dispersion, along with water added to balance to 100%. A batch at 20% pigment by weight was milled using a 0.6 L Netzsch LabStar® mill beaded with 0.3 mm YTZ media. Initial viscosity was 3.09 cps and initial particle size (d50) was 151 nm. After aging at 50° C. for four weeks, the resultant viscosity and median particle size was 193.5 cps and 481 nm, respectively. This sizable rise in viscosity vs. the inventive dispersions, shows that CD2 is unstable and unsuitable.

### Comparative Dispersion Example CD3 (Styrene Maleic Anhydride Dispersant)

Five parts of C.I. Pigment Black 7 (NuTone 302, Phillips Carbon) to 2 parts of Xiran 3000 HK resin (solids of dispersant on solids of pigment) was to make the pigment dispersion, along with water added to balance to 100%. A batch at 20% pigment by weight was milled using a 0.6 L Netzsch LabStar® mill beaded with 0.3 mm YTZ media. This dispersion gelled in the mill showing that it is not stable and not suitable.

### Comparative Dispersion Example CD4 (Acrylic Block Copolymer Dispersant)

Five parts of C.I. Pigment Blue 15:3 (249-LM84, Sun Chemical to 1 part of BYK 9171 (solids of dispersant on solids of pigment) was to make the pigment dispersion, along with water added to balance to 100%. A batch at 20% pigment by weight was milled using a 0.6 L Netzsch LabStar® mill beaded with 0.3 mm YTZ media. Initial viscosity was 4.90 cps and initial particle size (d50) was 395 nm. After aging at 50° C. for four weeks, the resultant viscosity and median particle size was 139.8 cps and 756 nm, respectively. This sizable rise in viscosity vs. the inventive dispersions, shows that CD2 is unstable and unsuitable.

### Comparative Dispersion Example CD5 (Styrene Acrylic Dispersant)

Four parts of C.I. Pigment Yellow 74 (272-3147, Sun Chemical to 1 part of Joncryl 674 solution (solids of dispersant on solids of pigment) was to make the pigment dispersion, along with water added to balance to 100%. A batch at 20% pigment by weight was milled using a 0.6 L Netzsch LabStar® mill beaded with 0.3 mm YTZ media. Initial viscosity was 282 cps and initial particle size (d50) was 353 nm. After aging at 50° C. for four weeks, the resultant viscosity and median particle size was 611.9 cps and 756 nm, respectively. This sizable rise in viscosity vs. the inventive dispersions, shows that CD2 is unstable and unsuitable.

The table below summarizes the data, where the dispersions from the inventive examples (minimal viscosity rise) are more stable than those of the comparative examples (either gelled or sizable viscosity rise)

TABLE 1
Stability Data based on particle size and viscosity

| | | d50 (nm)¹ | d50 | Visc. (cps)² | Visc. |
|---|---|---|---|---|---|
| Pigment | Dispersion | initial | (4 weeks) | initial | (4 weeks) |
| Yellow 74 | Inventive Example ID1 | 158 | 161 | 5.88 | 5.24 |
| Black 7 | Inventive Example ID2 | 155 | 155 | 2.86 | 2.64 |
| Quinacridone | Inventive Example ID3 | 186 | 166 | 4.05 | 3.90 |
| Blue 15:3 | Inventive Example ID4 | 165 | 167 | 4.80 | 5.40 |
| Blue 15:3 | Inventive Example ID5 | 157 | 162 | 4.83 | 5.04 |
| Quinacridone | Comp. Example CD1 | GELLED | GELLED | GELLED | GELLED |
| Black 7 | Comp. Example CD2 | 151 | 481 | 3.09 | 193.50 |
| Black 7 | Comp. Example CD3 | GELLED | GELLED | GELLED | GELLED |
| Blue 15:3 | Comp. Example CD4 | 395 | 756 | 4.90 | 139.80 |
| Yellow 74 | Comp. Example CD5 | 282 | 353 | 166.8 | 611.9 |

¹Particle size was measured using a Microtrac UPA ® 250 particle size analyzer with the particle mode being absorbing and with shape irregular.
²Viscosity was measured using a Brookfield DVII + Pro using small cell adapter with spindle 18 at 100 RPM.

Pigment dispersion compatibility with humectants and co-solvents is important. The humectants and co-solvents may be used for viscosity control, resolubility in printhead & penetration of substrate include but are not limited to: glycerine, propylene glycol, butyl carbitol, tetraethylene glycol, ethylene glycol, pyrrolidone, 1,2-hexanediol, 3-methoxy-3-methyl-1-butanol, triethylene glycol monobutyl ether, ethylene glycol monobutyl ether and methoxy propylene glycol. Selection may be important with regard to desired pigment stability in an ink, causing the pigment to grow in particle size or the ink to have an increase in viscosity.

Compatibility testing with glycerine was performed using model inks containing 20% dispersion (4% pigment), 30% glycerine and 50% deionized water. For butyl carbitol the model ink formula contained 20% dispersion (4% pigment), 7.5% butyl carbitol and 72.5% deionized water. Inks were aged at 60° C. for one week where particle size change was measured. The inventive examples exhibit excellent stability (minimal viscosity change) to glycerine and butyl carbitol. Results are shown in Table 2.

TABLE 2
Stability of Inks made with Inventive dispersions

| | | INITIAL | 1 WEEK |
|---|---|---|---|
| EXAMPLE | PIGMENT | PS (D50) | AGED PS (D50) |
| Glycerine Ink Made from | C. I. Pigment | 155 nm | 158 nm |
| Ex. ID1 Dispersion | Yellow 74 | | |
| Butyl Carbitol Ink Made | C. I. Pigment | 146 nm | 150 nm |
| from Ex. ID1 Dispersion | Yellow 74 | | |
| Glycerine Ink Made from | C. I. Pigment | 145 nm | 141 nm |
| Ex. ID2 Dispersion | Black 7 | | |
| Butyl Carbitol Ink Made | C. I. Pigment | 137 nm | 137 nm |
| from Ex. ID2 Dispersion | Black 7 | | |

The present development has been described in detail, including the preferred embodiments thereof. However, it will be appreciated that those skilled in the art, upon consideration of the present disclosure, may make modifications and/or improvements on this development that fall within the scope and spirit of the development.

1. A pigment dispersion comprising a polyurethane resin pigment dispersant comprising a water-based polyurethane polymer with pendant polyethylene glycol (PEG) groups appended on a carbon backbone of the polyurethane polymer, wherein the polyurethane polymer has units derived from a polyisocyanate, a polyol, a polyether polyol having no acid group, and a diol having an acid group; wherein the percentage (% by mass) of the unit(s) derived from the polyether polyol having no acid group in the polyurethane polymer is ≤50%; and wherein the polyether polyol having no acid group has a polystyrene-equivalent number-average molecular weight of between 450-4,000 as determined by gel permeation chromatography.

2. The pigment dispersion of claim 1, wherein the polyisocyanate is selected from the group consisting of aliphatic polyisocyanates, alicyclic polyisocyanates, aromatic polyisocyanates, aliphatic polyisocyanates and combinations thereof.

3. The pigment dispersion of claim 2, wherein percentage (% by mass) of the units derived from the polyisocyanate in the polyurethane polymer is ≥10% by mass to ≤80% by mass.

4. The pigment dispersion of claim 3, wherein the percentage (% by mass) of the unit(s) derived from the polyether polyol having no acid group in the polyurethane polymer is ≤50%.

5. The pigment dispersion of claim 4, wherein the polyether polyol is selected from the group consisting of poly(alkylene glycol)s, addition polymers of alkylene oxides, dihydric alcohols, and trivalent polyhydric alcohols.

6. The pigment dispersion of claim 1, wherein the polyisocyanate is hexamethylene diisocyanate in combination with a polyisocyanate with an intramolecular branched or ring structure.

7. The pigment dispersion of claim 5, wherein the dihydric alcohol is selected from the group consisting of, hexamethylene glycol, tetramethylene glycol, ethylene glycol, diethylene glycol, propylene glycol, dipropylene glycol, 1,3-butanediol, 1,4-butanediol, 4,4-dihydroxyphenylpropane, 4,4-dihydroxyphenylmethane and combinations thereof.

8. The pigment dispersion of claim 5, wherein the trivalent polyhydric alcohols are selected from the group consisting of glycerin, trimethylolpropane, 1,2,5-hexanetriol, 1,2,6-hexanetriol, and combinations thereof.

9. The pigment dispersion of claim 5, wherein the addition polymers of alkylene oxides are selected from the group consisting of ethylene oxide, propylene oxide, butylene oxide and alpha-olefin oxides and combinations thereof.

10. The pigment dispersion of claim 1, comprising a unit derived from dimethylolpropionic acid (DMPA) and 2,2-dimethylolbutanoic acid (DMBA) as a diol having an acid group.

11. The pigment dispersion of claim 10, wherein the diol having an acid group is a salt selected from the group consisting of Li, Na, or K, an organic amine, and ammonia.

12. The pigment dispersion of claim 1, further comprising a chain extension agent wherein the chain extension agent is selected from the group consisting of polyvalent amine compounds, such as trimethylolmelamine and derivatives thereof; dimethylolurea and derivatives thereof; dimethylolethylamine; diethanolmethylamine; dipropanolethylamine; dibutanolmethylamine; ethylenediamine; propylenediamine; diethylenetriamine; hexylenediamine; triethylenetetramine; tetraethylenepentamine; isophoronediamine; xylylenediamine; diphenylmethanediamine; hydrogenated diphenylmethanediamine; hydrazine; polyamide polyamine; polyethylene polyimine; ethylene glycol; propylene glycol; 1,3-propanediol; 1,3-butanediol; 1,4-butanediol; 1,5-pentanediol; 1,6-hexanediol; neopentyl glycol; diethylene glycol; triethylene glycol; tetraethylene glycol; dipropylene glycol; tripropylene glycol; poly(ethylene glycol); 3-methyl-1,5-pentanediol; 2-butyl-2-ethyl-1,3-propanediol; 1,4-cyclohexanediol; 1,4-cyclohexanedimethanol; hydrogenated bisphenol A; glycerin; trimethylolpropane; pentaerythritol and combinations thereof.

13. The pigment dispersion of claim 1, further comprising a resin co-dispersant, wherein the resin co-dispersant is selected from the group consisting of acrylic acids, methacrylates, styrene acrylics, styrene maleic anhydrides and combinations thereof.

14. The pigment dispersion of claim 1, further comprising one or more additives, wherein the one or more additives are selected from the group consisting of biocides, defoamers, humectants and pH adjustors.

15. The pigment dispersion of claim 1 which is a printing ink, optionally wherein the printing ink is an inkjet ink.

16. The pigment dispersion of claim 1, wherein the water-based polyurethane polymer is ionic.

17. The pigment dispersion of claim 1, wherein the water-based polyurethane polymer is non-ionic.

18. The pigment dispersion of claim 1, wherein the pigment is quinacridone, such as quinacridone magenta.

19. The pigment dispersion of claim 1, further comprising glycerine or butyl carbitol.

20. Use of a polyurethane resin in an inkjet ink for improving resolubility in printhead and penetration of the substrate, wherein the polyurethane resin is a polyurethane resin pigment dispersant comprising a water-based polyurethane polymer with pendant polyethylene glycol (PEG) groups appended on a carbon backbone of the polyurethane polymer, and wherein said ink comprises said polyurethane resin in the form of a pigment dispersion and said ink further comprises a co-solvent and humectant selected from glycerine, propylene glycol, butyl carbitol, tetraethylene glycol, ethylene glycol, pyrrolidone, 1,2-hexanediol, 3-methoxy-3-methyl-1-butanol, triethylene glycol monobutyl ether, ethylene glycol monobutyl ether and methoxy propylene glycol.

21. The use according to claim 20, wherein the polyurethane resin pigment dispersant is the polyurethane resin pigment dispersant.
